(19) United States
(12) Patent Application Publication
(10) Pub. No.: US 2009/0022955 A1
(43) Pub. Date: Jan. 22, 2009

(54) High definition patterning of thermoplastic substrates

(76) Inventors: Franklin Sadler Love, III, Columbus, NC (US); Frank M. Pitman, Duncan, SC (US); Howard C. Willauer, Spartanburg, SC (US)

Correspondence Address: Jeffery E. Bacon;Legal Department, M-495, P.O. Box 1926, Spartanburg, SC, 29304, US

(21) Appl. No.: 12/075,279

(22) Filed: Mar. 10, 2008

Related U.S. Application Data
(60) Provisional application No. 60/961,056, filed on Jul. 18, 2007.

(51) Int. Cl. B32B 3/00; D06C 23/00

(52) U.S. Cl. 428/156; 26/2 R

(57) ABSTRACT

An apparatus and method for imparting a permanent, high resolution pattern to a heat-settable fabric, particularly one having a pile-like surface, using modulated streams of pressurized heated air that are individually controllable and electronically addressable, using a patterning technique capable of extremely fine gauge (i.e., high dots-per-inch or high pixel count) and extremely fine carve depth control (e.g., allowing for multiple finely spaced carve levels, as compared with techniques in the prior art), and which results in the formation of patterns of extraordinary resolution, definition and detail without the harsh hand associated with prior art techniques in which fibers and yarns are melted within patterned areas.

### CROSS REFERENCE TO RELATED APPLICATIONS

This application claims priority to U.S. application Ser. No. 60/961,056 filed on Jul. 18, 2007

### TECHNICAL FIELD

This disclosure is directed to an apparatus and method for imparting a permanent, high resolution pattern to a heat-settable fabric, particularly one having a pile-like surface, using modulated streams of pressurized heated air that are individually controllable and electronically addressable. More specifically, the apparatus and method described herein are directed to a patterning technique capable of extremely fine gauge (i.e., high dots-per-inch or high pixel count) and extremely fine carve depth control (e.g., allowing for multiple finely spaced carve levels, as compared with techniques in the prior art), and which results in the formation of patterns of extraordinary resolution, definition and detail without the harsh hand associated with prior art techniques in which fibers and yarns are melted within patterned areas.

### BACKGROUND

To those skilled in the art of pattering textile fabrics, it is generally known that directing sufficient heat at a heat-sensitive fabric can impart a pattern, via the localized shrinking and melting of individual heat sensitive (e.g., thermoplastic) fibers or yarns comprising the fabric. Such patterning has traditionally been accomplished in several ways, among them (1) by thermal “brushing” through a stencil using an indiscriminate stream or band of heated fluid, with the areas that are to be free of carving being protected from the effects of the heated air by the stencil material (the “stencil” technique), (2) by the selective, pattern-wise impingement of a suitably modulated source of focused radiation, such as a relatively high energy laser (the “laser” technique), (3) through the use of chemical etching agents, perhaps also with the aid of a stencil to deliver the etchant to the proper locations on the fabric surface (the “chemical etch” technique), (4) by embossing using a heated embossing roll (the “embossing” technique), or (5) by the impingement of a plurality of individually formed and controlled streams of heated air that can selectively heat, shrink, and melt predetermined areas of the fabric that are to carry the pattern (the “multiple discrete stream” technique).

As used herein, high resolution patterns shall refer to relatively fine gauge patterns—those having high two-dimensional pixel count or “dots-per-inch” values, i.e., greater than 40 d.p.i., and shall be used to describe patterns in which exceedingly small pattern elements can be precisely and accurately delineated from immediately adjacent areas on the fabric surface, including the crispness of the boundary separating such pattern elements, including the smallest, from their surroundings. High definition patterns shall refer to patterns having both high resolution and a sufficiently high number of carve levels (i.e., distinct levels of displaced pile height) to produce substantially imperceptible gradations between shallow and deep carve levels wherever the pattern requires a gradual transition, and extremely sharp and crisp transitions between different carve levels wherever the pattern so requires.

Prior art implementations of the stencil technique have limited the pattern repeat length to the length of the stencil, and have limited changes to the pattern by requiring the formation and/or installation of a separate stencil, as opposed to being able to change the pattern electronically or on-the-fly. Prior art implementations of the laser technique have been limited by the cost of the laser and the appropriate control electronics necessary to move and modulate the laser across the surface of the fabric in accordance with electronically-defined pattern data and, importantly, by the need to rely exclusively on thermal energy, rather than a combination of thermal and mechanical energy, to achieve a patterning effect. The use of chemical etching agents, although capable of producing patterns having high resolution and detail, are much less able to achieve patterns having multiple levels of carve depth, and can suffer from the same shortcomings identified above concerning the use of stencils. Furthermore, such chemical etch techniques generally are cost-intensive, environmentally troublesome (because of the reactivity of the etching agents used) and, because they result in actual removal of a portion of the substrate, raise issues of loss of strength and/or cover. Both laser techniques and chemical etch techniques have been found to be problematic in their ability to reproduce reliably patterns having finely spaced carve levels with no significant melting of individual pile yarns. The use of a heated embossing roll is similarly cost-intensive, as a new embossing roll must be assembled and/or installed each time a pattern change is needed. Furthermore, because of the interaction between closely-spaced, adjacent pattern protrusions on the embossing roll with the pile yarns on the substrate surface, use of an embossing roll cannot achieve intricate detail—the pile yarns in the gap between closely-spaced adjacent pattern protrusions on the roll tend to be unintentionally displaced by the pattern protrusions, resulting in a loss of definition on the patterned fabric in such areas.

Prior art implementations of the multiple discrete stream technique are exemplified by the teachings of commonly assigned U.S. Pat. No. 5,148,583, in which the formation and/or control of the individual streams of heated air is accomplished through the use of transverse streams of cold air for the purpose of forming or selectively blocking the heated air streams impinging on the fabric surface. This approach has been limited to relatively coarse gauges (i.e., 40 d.p.i. or less, measured across the width of the fabric web) in order to (1) achieve necessary production speed, (2) overcome the mechanical limitations inherent in any system in which multiple fluid streams must be heated to a uniform temperature and then modulated by means of corresponding cooler air streams that are introduced transversely for the purpose of diluting or blocking the heated air streams, and (3) minimize the physical limitations that accompany efforts to direct extremely hot fluid streams at highly localized areas on the fabric surface without visibly affecting the fabric in immediately adjacent areas due to spreading of the thermal energy to such adjacent areas. Such limitations include overcoming the inherent imprecision and response time issues associated with forming, delivering, and dissipating the pneumatic pulses of cooler air that are responsible for controlling the delivery of the heated air streams to the fabric surface, and, importantly, overcoming the effects of the melting of fibers, which results in a corresponding deterioration of hand and an increase in lint retention (perhaps due to the formation of melted protuberances at the tips of the pile yarns that tend to grab and shelter lint particles from the effects of brushing).

U.S. Pat. No. 5,148,583 describes an elongate manifold assembly that extends across the path of the substrate to be patterned, with an elongate exit slot that extends the length of the manifold and is positioned closely and in parallel relation to the surface of the substrate to be patterned. The gas is directed onto the substrate as a thin, continuous stream or curtain extending the length of the manifold. Patterns are created through the use of transverse blocking streams of relatively cool gas which serve to form, deflect and dilute selected lateral segments of the heated gas curtain after the curtain of heated gas emerges from the exit slot, allowing undeflected segments of heated gas to directly impinge upon the surface of the substrate with sufficient thermal energy to modify and pattern the surface of the substrate through the selective shrinking and/or melting of the constituent fibers or yarns comprising the surface of the substrate.

This process has significant limitations if fine-scale, subtle patterning is desired, among them (1) the degree with which the number of individual streams of heated fluid (e.g., air) necessary for high resolution patterning (i.e., greater than 40 d.p.i.) can be formed and controlled with precision and accuracy using separate control streams, and (2) the speed with which the heated air can be directed onto or diverted from the fabric being patterned. These two limitations serve to limit both the speed at which the fabric can be patterned and moved and the level of detail that can be imparted to a patterned area. Furthermore, the extent to which patterning streams of gas having intermediate levels of temperature or pressure can be generated is also limited, which therefore limits the capability of this process to generate on-the-fabric fine scale gradations in carve depth, with a corresponding loss in the capability to express pattern detail. The teachings of U.S. Pat. No. 5,148,583 provide no means, and do not contemplate, hot air streams in which the pressure, but not the temperature, is varied. Even in the absence of these considerations, the presence of melted pile yarns in patterned areas in which deep carve levels are employed inevitably raises issues concerning degradation of the hand of the patterned fabric and the creation of relatively abrasive surfaces in such pattern areas, particularly where the pattern requires deep carve levels within an area larger than a few square millimeters.

### SUMMARY

The method and apparatus comprising the patterning system disclosed herein is particularly suited to efficiently imparting a high resolution pattern having high definition to a heat-settable fabric, and particularly a fabric having a pile comprised of heat-settable yarns, with no loss of hand due to the presence of melted pile yarns, even in areas having deep carve levels.

Fundamentally, the disclosed method and apparatus is based upon a patterning module comprising an electrically actuated control valve that modulates, in accordance with electrically encoded pattern data, the pressure of a narrow, precisely defined stream of pressurized heated fluid (e.g., air) that directly impinges the surface of the fabric to be patterned at a controlled angle of attack. By use of a fluid stream having a predetermined, uniform temperature that avoids pile yarn melting and use of a valve that directly regulates the pressure of the impinging fluid stream, it has been discovered that the patterning effect of the fluid stream may be rapidly and precisely modulated, using a plurality of discrete pressure levels, in accordance with the electrical signal supplied to the control valve, and, importantly, that the depth of carve (i.e., the degree of observable pile yarn vertical displacement and/or pile yarn shrinkage) is, to a surprising degree, nearly linearly proportional to the pressure of the applied fluid stream. The result is an unprecedented ability to control the depth and degree to which localized areas of the fabric surface may be patterned, particularly in areas of the substrate in which (1) high resolution patterning is required and/or (2) relatively large areas of the pattern require deep carve levels with no loss of hand. Possible for the first time is the creation of permanent, multi-level patterns in pile substrates that exhibit dramatically higher levels of pattern definition and subtlety than have been achievable with the devices and processes of the prior art, while avoiding the creation of deeply carved areas having melted pile yarns.

The pattern is imparted to the pile substrate through a combination of the thermal and mechanical energy contained in the stream of heated fluid. The mechanical energy provided by the pressurized stream serves to displace or lay over the pile yarns in a precisely controllable way (varying in nearly direct proportion to the pressure of the stream), while the thermal energy imparted by the heat of the pressurized stream heat both softens the pile yarns (making them more readily displaced at a given stream pressure) and heat sets the displaced pile yarns following their displacement. In many cases, the thermal energy also shrinks the displaced yarns to a limited degree, providing additional permanence to the pattern, although it is believed that thermally-induced shrinkage is secondary to pile displacement/heat setting as the mechanism responsible for the carved appearance of the pile surface. The amount of heat delivered is controlled to prevent melting of the fibers, which is associated with deterioration in the hand of the fabric. Use of multiple patterning modules, arranged in a way that provides for close spacing of the patterning streams (“pattern jets”) on the substrate surface to provide high resolution patterning (e.g., having pattern jets arranged along a diagonal to emulate close side-to-side spacing, with remote placement of the individual control valves) is contemplated.

### BRIEF DESCRIPTION OF THE FIGURES

FIG. 1 schematically depicts, in cross section and block form, several major components used to implement the pile fabric patterning system disclosed herein, as shown in a configuration suitable for patterning a pile fabric substrate in the form of a moving web.

FIG. 2 represents a block flow diagram of major components and/or processes associated with one embodiment of the patterning system contemplated herein. Component numbering corresponds to components found in FIG. 1.

FIG. 3 charts the effects of increases in pattern jet pressure on measured carve depth on a 100% clipped knit polyester pile substrate. The chart indicates the nearly linear nature of the relationship.

FIG. 4 charts the effects of temperature on carve depth on a 100% clipped knit polyester pile substrate, demonstrating that the jet pressure required for a given carve depth is much greater at room temperature (75° F.) than it is at an elevated temperature, in this case, 390° F.).

FIG. 5 is a schematicized side view of the patterning head, showing its position relative to a substrate being patterned. Shown is a plurality of individual jet tubes mounted within a heater block that heat and form the individual patterning jets. Although not shown, each jet tube is connected to a supply of pressurized air via an individually controlled valve that modulates, in accordance with electronic pattern data, the individual pressure at which each of the pattern jets is directed onto the substrate surface fabric.

FIG. 6 is a section view taken along lines VI-VI of the pattern head of FIG. 5, showing the oblique orientation of the jet tubes (to emulate the close side-to-side spacing used for high resolution patterning) that form and direct the heated, pressurized patterning jets or streams onto the fabric surface.

FIG. 7A is a perspective view of one embodiment of a patterning device that may be used to pattern pile fabrics in a “batch mode” process, using the novel teachings herein. Full width patterning is achieved by traversing the patterning head along the length of the support roll, in close proximity to the fabric surface, as the fabric is incrementally rotated on the drum to which it is attached. Pattern length is limited to the size of the drum used.

FIG. 7B is a perspective view of another embodiment of a patterning that may be used to pattern pile fabrics in a “continuous mode” process, using the novel teachings herein. Full width patterning (and full length patterning as well, to the extent desired) is achieved by using an elongate patterning head that is positioned in close proximity to the fabric surface and that extends across the width of the web of fabric to be patterned. As the fabric web moves past the patterning head, different jets comprising the pattern head are actuated to produce the desired pattern.

FIG. 8A represents the surface of a 100% clipped knit polyester pile fabric, having a pile containing heat-settable yarns, that has been patterned with the novel apparatus and method described herein.

FIG. 8B is a cross-sectional representation of the patterned fabric of FIG. 8A (with the cross-section taken through Section VIIIB-VIIIB), depicting both the extremely smooth gradations (depicted at 58) and extremely abrupt transitions (depicted at 59) of pile height that characterize high definition patterning and that can be achieved with the apparatus and method described herein.

FIG. 9 is a plan view of the surface of a 100% clipped knit polyester pile fabric patterned using the techniques disclosed herein. The fabric carries a pattern that imparts a complex texture to the fabric, along with a “Tromp d'Oeil”-like illusion of three-dimensional, sinuous pleats or gathers. The fabric is, in fact, planar.

FIGS. 10A through 10C are electron photomicrographs of a 100% clipped knit polyester pile fabric. FIG. 10A is a cross-section of the pile, at 35×, prior to patterning. FIG. 10B is a cross-section of a patterned area of the fabric of FIG. 10A, seen at slightly higher magnification (50×), patterned using the techniques of U.S. Pat. No. 5,148,583. Note the melting of the tips of the pile yarns in the patterned area. FIG. 10C is also a cross-section (at 50×) of a patterned area of the fabric of FIG. 9A, but patterned using the novel techniques disclosed herein. Note the absence of melting of the pile yarns in the treated (i.e., patterned) area.

FIGS. 11A through 11D are electron photomicrographs of another 100% clipped knit polyester pile fabric. FIG. 11A is an oblique view of the surface of untreated fabric at 30×. FIG. 11B is an oblique view (at 30×) of a patterned area of the fabric of FIG. 11A following patterning using the techniques of U.S. Pat. No. 5,148,583. Note the melting of the tips of the pile yarns in the patterned area. FIG. 11C is a cross-section view (at 25×) of a patterned area of the fabric of FIG. 11A following patterning using the novel techniques disclosed herein. FIG. 11D is a cross-section view (at 25×) of an area of the fabric of FIG. 11A, also carved using the novel techniques disclosed herein, showing a deeply carved area to the right. Note that, even in such deeply carved area, there is no evidence of the melting observed in FIG. 11B, but, instead, large numbers of pile fibers that have been displaced and heat set in that displaced position.

### DETAILED DESCRIPTION

Although it is contemplated that fluids other than air may be used, and that substrates other than textile fabrics having elements that form a pile-like surface (e.g., fabrics such as woven or knitted pile fabrics, tufted or flocked substrates, suedes, non-wovens having a pile-like surface, etc.) may be used, the discussions that follow will be primarily directed to an embodiment in which the fluid is air and the substrates are textile fabrics having a heat-settable pile comprised of polyester, nylon, or other thermoplastic yarns or fibers that are capable of being displaced and heat set without significant melting by the patterning system described herein.

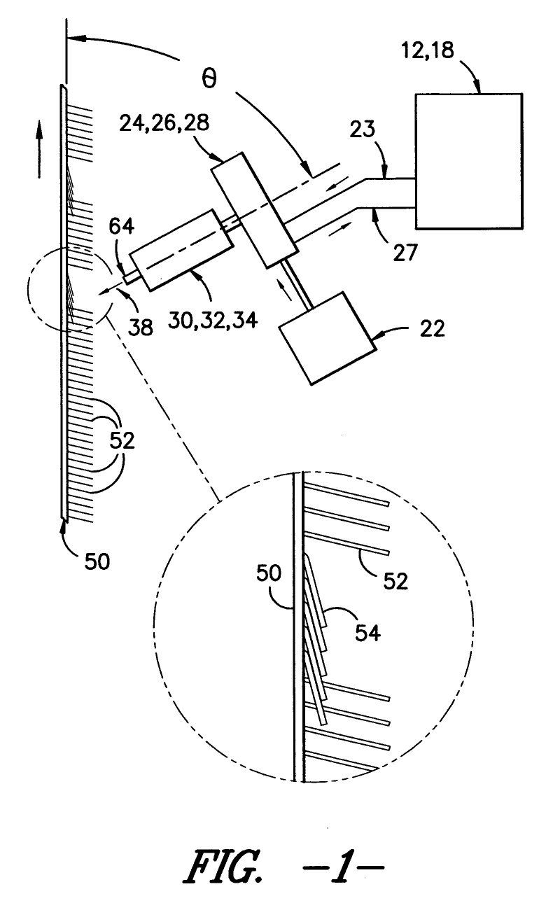

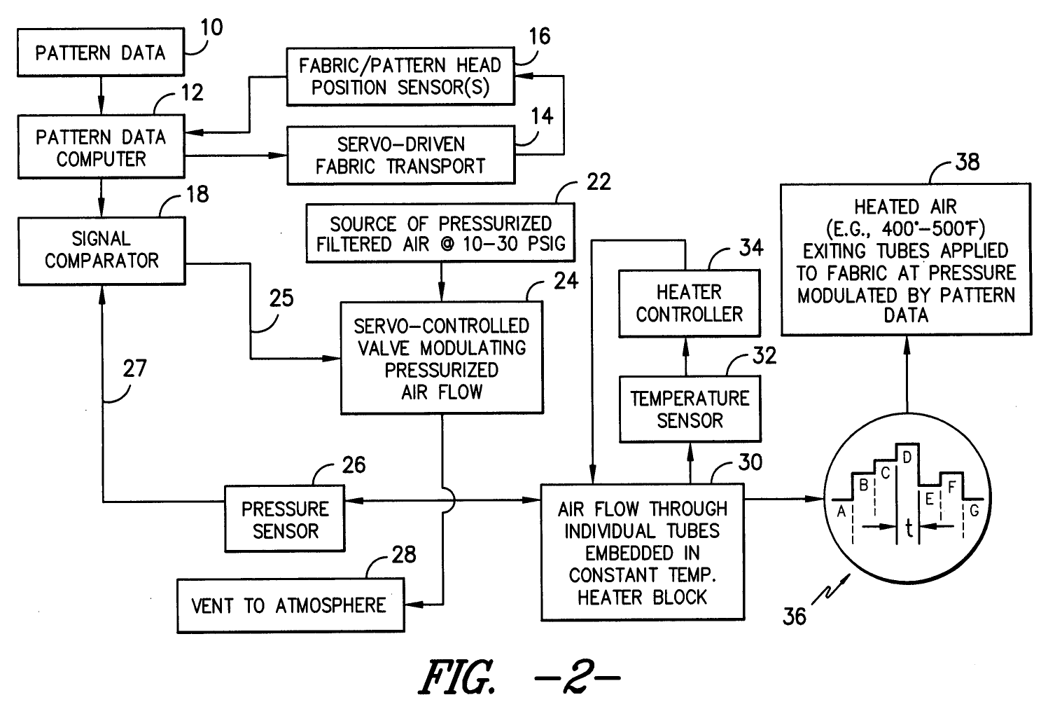

FIG. 1 is a schematicized diagram depicting, in cross section, an apparatus embodying the novel patterning process disclosed herein in a configuration suitable for patterning a pile substrate in the form of a moving web. In highly simplified form, source 22 provides filtered and pressurized air to “smart” valve assembly 24, 26, 28 at a pressure that will not damage the valves used and that will allow the valves to generate a patterning air stream at the highest valve inlet pressure at which patterning is to be done—perhaps within the range of about 10 p.s.i.g. to about 30 p.s.i.g. It should be noted that, due to the small diameter of jet tubes 64, there is a substantial pressure drop from the inlet to the outlet ends of tubes 64, causing the tube outlet pressure to be perhaps 10% or less of the valve inlet pressure. It should be noted that, because of the pressure drop between the jet tube inlet and outlet, the supplied pressure to the valve assembly is generally on the order of ten times the pressure of the patterning jets exiting jet tubes 64 and applied to the substrate. Smart valve assembly 24, 26, 28 is capable of taking digitized pattern data from computer/signal comparator 12, 18 (the data being expressed as a series of discrete pressure values, one for each short time interval over which computer 12, 18 is sequentially cycled to refresh pattern data), and generating an air stream having, for each such time interval (hereinafter referred to as a pattern data cycle), a discrete, non-varying air pressure corresponding to that specified by the pattern data for that pattern data cycle. The resulting pulse train of discrete pressures is depicted at 36 in FIG. 2, which shows individual air pressure values “A” through “G”, each of which has uniform duration “t” that corresponds to the length of the pattern data cycle and a predetermined pressure value that remains constant throughout the pattern data cycle. In the case depicted, each cycle calls for a different pressure value and will result in the formation of a series of pixel-sized carved areas, each having a distinctly different carve level. Where a specific area of the substrate is to be patterned using a uniform carve level, the pressure values will be uniform as well for that portion of the patterning process.

Control lines 23, 27 establish a pressure control servo-loop between “smart” valve assembly 24, 26, 28 and computer/signal comparator 12, 18 that allows valve assembly 24, 26, 28 to establish and maintain the precise pressure specified by the pattern data during any given pattern data cycle. It should be noted that use of a “smart” valve assembly having such functions already integrated into the valve assembly, such as a Pneutronics Model SE03561, supplied by Pneutronics, Inc. a division of Parker-Hannifin, of Hollis, N.H., is a preferred option. However, other valves from other manufacturers may be used, with the necessary servo-loop elements (e.g., pressure sensors, signal comparators, etc.) being implemented as individual or “outboard” components.

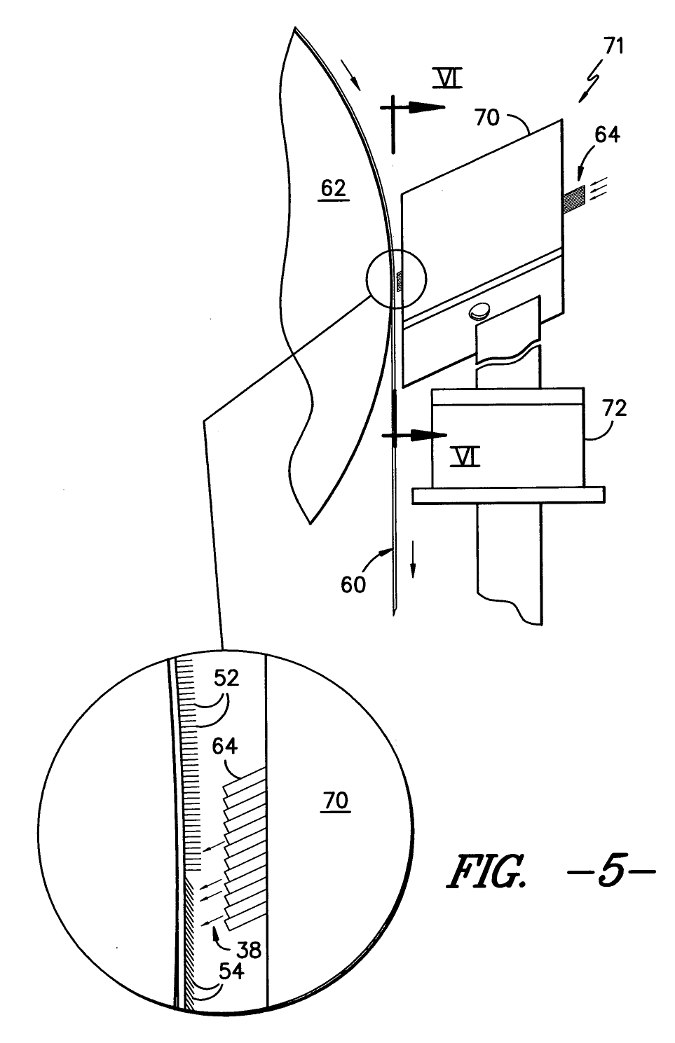

The pressure-modulated air stream from a single “smart” valve assembly 24, 26, 28 is fed, via an appropriate conduit (e.g., plastic tubing), into a small-diameter jet tube (shown at 64 in FIG. 1 and in FIGS. 5 and 6) embedded in a heater block, which is schematically depicted at 30 in FIGS. 1 and 2, and more descriptively depicted in a preferred embodiment in FIGS. 5 and 6 as comprising mating blocks 70 that are appropriately contoured to accept and surround in close physical contact a plurality of tubes 64. In commercial embodiments, multiple valves assemblies, conduits, and jet tubes are used. Associated with block 30 and jet tubes 64 is a temperature-controlling servo loop, indicated here as 32, 34 and explained in more detail in connection with FIG. 2, to maintain a pre-determined constant temperature within the block and, therefore, provide uniform heat conduction and transfer to the pressurized stream of air within each jet tube 64 passing through heater block 30. By passing through jet tube 64, the air stream is simultaneously formed into a patterning jet and heated to a predetermined, carefully maintained temperature before being directed onto the pile surface of the substrate to be patterned. Note that a preferred embodiment for a patterning device will include multiple valves and associated jet-forming tubes, optionally in a one-valve-for-each-jet tube configuration, thereby allowing each pattern jet to be individually controllable and maximizing the patterning versatility of the device. However, it is contemplated that a single valve may be connected to multiple jet-forming tubes if generating patterns having high levels of detail and complexity are not high priorities.

Preferably, the temperature of the patterning jet emerging from jet tube 64 as it strikes the pile yarns 52 is sufficient to induce heat setting in the pile yarns 54 of substrate 50, but not high enough to induce observable melting in those pile yarns—i.e., a non-melting heat set temperature. In many cases, this implies a temperature within the range of about 350° F. to about 490° F., depending upon the properties of the substrate. It has been found that, for maximum physical displacement of the pile yarns at a given patterning jet pressure, angle θ should be selected to direct the pressurized air streams perpendicular to the upright pile yarns, although deviations from this preferred angle will certainly yield acceptable results under many conditions, as suggested by the configuration of FIG. 1. Because preferred angle θ will vary according to the angle of pile lay found in the substrate, a brushing operation prior to patterning to orient the pile uniformly to a predetermined angle of pile lay—perhaps to provide for the perpendicular orientation discussed above—may be advantageous.

The block diagram of FIG. 2 presents an overview of the apparatus described in FIG. 1, but provides more detail with respect to individual components and/or functions that might be found in a representative embodiment. Pattern data 10 are sent to computer 12, which generates individual pressure values for each patterning jet for each pattern data cycle. The pattern data cycle frequency is determined by two principal factors: (1) the necessary dwell time or exposure time during which the fabric surface must reside opposite an individual jet in order to be permanently patterned, and (2) the desired level of pattern resolution (i.e., the desired number of individually addressable pattern “pixels” per unit area of fabric surface—in other words, the desired “dots per inch” resolution). For a given number of patterning jets, these two factors are largely responsible for establishing an upper limit on the speed at which the fabric can be patterned. Generally speaking, an increase in the number of patterning jets can allow for a proportional increase in patterning speed.

An additional parameter determining pattern definition is the number of different levels of pressure that can be reliably delivered by the valve system used to meter the air pressure to the patterning jets. This value determines the number of different carve depth levels available for reproducing the desired pattern, and can range from some arbitrary, single digit minimum value to dozens or hundreds of discrete values—it is essentially limited only by the response characteristics of the selected valve system and, as a practical matter, the capability of the selected substrate to reflect such fine gradations in carve depth. Having a choice of at least about ten different carve levels is recommended for many applications, but having about twenty or more available carve levels may be preferred to achieve a truly high definition pattern using some substrates, e.g., those with a relatively deep pile. Values that result in barely perceptible changes in the appearance of adjacent patterned areas, or that result in differences in carve depth that are measurable but not necessarily readily apparent visually, shall be referred to as patterning that is substantially continuous with respect to carve depth, and may require about thirty, forty, or more available discrete carve levels, depending upon the nature of the substrate.

The timing of the pattern data flow from computer 12 is synchronized with the position of the fabric relative to the patterning head by means of a feedback loop comprised of the fabric transport mechanism (driven by a servomotor) and transport position sensor 14 that quantifies the position of the transport (and therefore the position of the fabric to be patterned) with respect to the patterning head, and, if a traversing patterning head is used, a pattern head position sensor 16 that further determines the lateral position of the individual patterning jets relative to the fabric. Working together in a manner well known to those skilled in the art, the control loop represented by computer 12, transport position sensor 14, and, if used, patterning jet position sensor 16 (hereinafter referred to as the data/transport control loop) allows computer 12 to synchronize the output of pattern data to the print head with the arrival under the print head of the physical location on the fabric (the “target location”) to which that specific portion of the pattern data has been assigned in order to reproduce the desired overall pattern. It is anticipated that commercial patterning systems based on the disclosures herein will employ multiple patterning jets, perhaps arranged in multiple arrays, with corresponding adaptations (perhaps based on the disclosures found in commonly assigned U.S. Pat. Nos. 4,984,169; 5,128,876; 5,142,481; 5,195,043; and 5,208,592, the content of which is hereby incorporated by reference) made to the control system to allocate patterning data to the appropriate array of patterning jets and to the appropriate individual patterning jets within such array.

As part of the operations necessary to achieve the high level of pattern definition and accuracy to which this patterning system is capable, several signal processing/control steps are carried out in real time, initiated by the passage through signal comparator 20 of the pattern data assigned to a specific target location on the fabric. The pattern data specify the air pressure at which a given patterning jet should be actuated during a single control system cycle. Assuming a pattern system cycle frequency of 48 Hz (purely an exemplary value), then every 1/48^{th} of a second (the pattern data cycle time “t” depicted at 36 in FIG. 2), pattern data computer 12 will output a value that specifies the pressure, selected from perhaps dozens or hundreds of distinct pressure levels (depending upon the desired level of pattern definition and subtlety), at which the heated air should be directed onto the fabric for that control system cycle. Following a conversion step in which the digital values are normalized within a specified voltage range compatible with the selected valve (e.g., if 100 distinct carve levels are desired and the valve is specified to transition from fully closed to fully open in response to a voltage rise of zero to ten volts, then the smallest incremental carve levels would be specified by a change in voltage of 0.1 volts), the series of voltage pulses that carry the coded pattern data is sent to a signal comparator 18. It has been found that, when using the Pneutronics valve assembly discussed above with commonly available pile substrates comprising nylon or polyester, incremental carve levels that are substantially continuous may be achieved using a change in voltage within the range of about 0.05 volts to about 0.5 volts (depending upon the nature of the substrate, the temperature of the patterning jet, and other factors).

Looking at FIG. 2, this pressure data is sent first to signal comparator 20 and then to servo-controlled valve assembly 24. Note that, in the case of the Pneutronics Model SE 03561, comparator 20 is integrated into valve assembly 24. Each valve assembly 24 is connected to an individual jet tube 64, as well as a source of pressurized filtered air 22 by means of suitable conduits (e.g., flexible plastic tubing, not shown). Valve assembly 24 serves to modulate the pressure of the air supplied by pressurized filtered air source 22 that is passed to the patterning jet in accordance with the pattern data output of computer 12. The step of converting the digitally-encoded pattern data into a signal pulse in which the pressure values are expressed as a series of discrete, non-varying “analog” values may be done using a separate digital-to-analog converter, perhaps associated with computer 12. Together with pressure sensor 26 (which measures the pressure of the air being sent to each jet tube 64), valve assembly 24 and signal comparator 20 form a second control loop (hereinafter referred to as the pressure control loop) that serves to monitor and minimize, in real time, the difference between the pressure specified by the pattern data and the actual pressure being delivered to each jet tube 64 (and, by implication, the actual air pressure being directed towards the substrate in the form of a patterning jet, which pressure will be different from—but closely correlated with—the measured pressure due to the large pressure drop across the length of tubes 64). Although shown as a separate component, pressure sensor 26 may also be integrated into the valve assembly, as is done in the Pneutronics valve specified above.

This pressure control loop preferably operates at a frequency that is somewhat higher than the pattern data cycle frequency, i.e., preferably at a frequency that is at least three or four times the pattern data cycle frequency, and more preferably at a frequency that is perhaps five to ten times that frequency or more, depending upon the level of precision and accuracy that is desired, the limitations of the equipment used, and other factors. By so doing, the actual pressure level being delivered to the pattern jet in response to a single pattern-specified pressure value may be sampled multiple times and adjusted in real time to more accurately implement the specified pressure level (and corresponding depth of carve exhibited in the fabric).

During most of the pressure control loop cycle, the pressure control loop operates as follows. The pressure data is sent to valve assembly 24 and the resulting pressure entering the jet tube 64 is measured and sent to comparator 20. Signal comparator 20 then generates an error signal representing the difference between the pressure specified by the pattern data (P_{specified}) and the pressure actually generated by the valve assembly in response to that pattern data (P_{actual}). The error signal (P_{specified}−P_{actual}=ΔP) is then superimposed onto the discrete “analog” signal being fed to the valve assembly during the next pressure control loop cycle, resulting in a single-variable servo loop that, within the errors associated with the equipment, assures that the air pressure sent to the individual patterning jets comprising the patterning head accurately tracks the air pressure specified by the pattern data (i.e., P_{specified}≈P_{actual}) in real time.

Optionally, special processing may be used for the first pressure control cycle of each pattern data cycle. For the first cycle of the pressure control loop (i.e., on the initiation of a new pattern data cycle), an error signal may not be available, as there would have been no opportunity for the signal comparator to have developed an error signal appropriate to the new pattern data. In that case, signal comparator 20 may forward the specified pressure value to valve assembly 24 without generating and superimposing an error signal. Alternatively, the error signal from the immediately previous pressure control loop cycle, if available, may be used—if the pressure control loop frequency is sufficiently higher than the pattern data cycle frequency, the influence of a single inappropriate error signal may be minimal compared with the duration of the pattern data cycle, and the need to provide for special processing may be avoided.

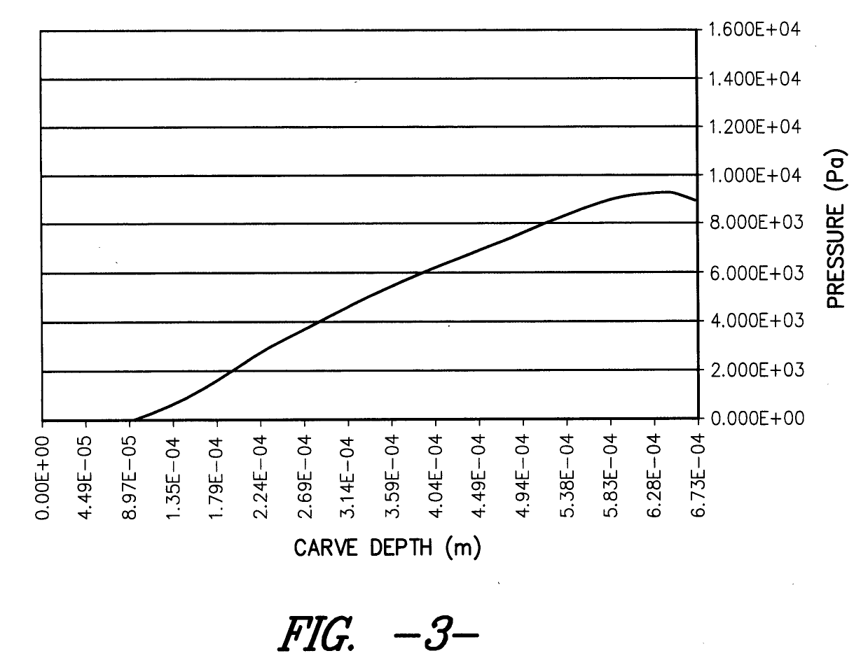

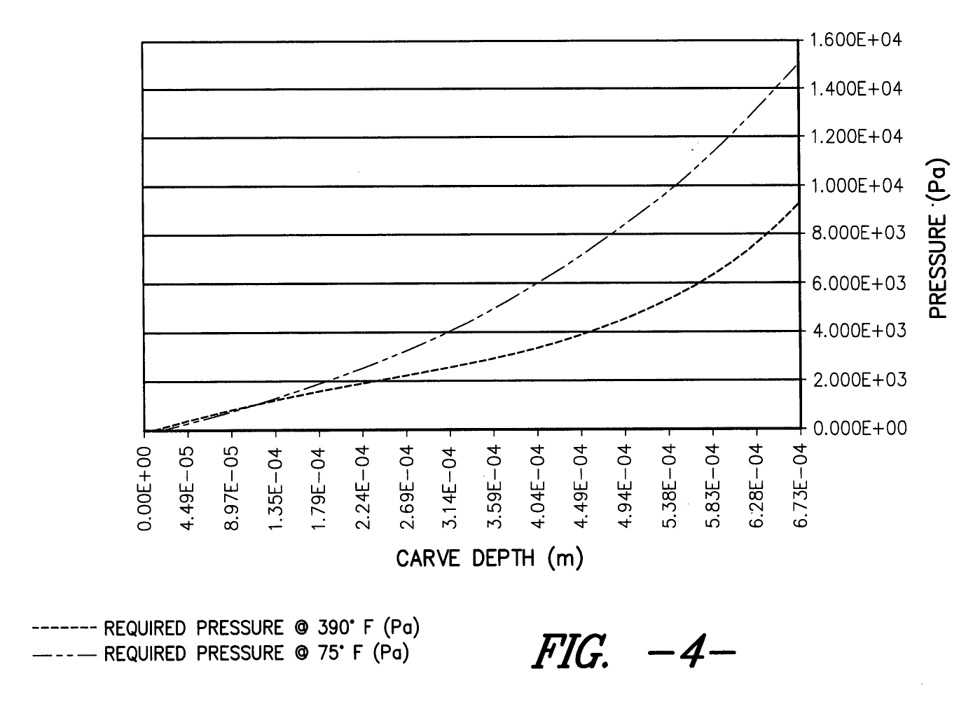

FIGS. 3 and 4 chart the degree to which increases in patterning jet pressure affect carve depth. FIG. 3 is a plot of carve depth (measured on a 100% polyester pile fabric using a laser) vs. patterning jet pressure (measured at a distance from distal end of jet tube 64—that end closest to the substrate—equivalent to the surface of a substrate to be patterned), with pressurized air at room temperature. It should be noted that, while the carve depth indicated on the chart extends to about 0.7 mm (at a room temperature patterning jet pressure of about 1.3 p.s.i.g.) increased carve depth can be achieved by using a combination of higher inlet pressures (i.e., those approaching 25-30 p.s.i.g.) and an increase in the patterning jet temperatures.

FIG. 4 demonstrates the effect of temperature on carve depth, at two simulated patterning jet temperatures. These data were obtained using a MTS SINTECH Model 10/G testing machine (available from MTS Systems Corp., of Eden Prairie, Minn. 55344 or Holly Springs, N.C. 27540) as a compression tester. A 100% polyester pile fabric was compressed in a highly localized area, and a force vs. displacement curve was generated for the fabric at room temperature and at 490° F. As shown, throughout most of the range, a given patterning jet pressure will result in a greater carve depth at elevated temperatures—presumably, such temperatures cause a heating and softening of the pile yarns or fibers, making them more susceptible to deflection or displacement than pile yarns or fibers at or near room temperature. In any case, it is preferred that the patterning jet be sufficiently hot to allow for the desired deflection of the pile yarns or fibers, and to heat-set such yarns and fibers in their deflected position.

Heating blocks 70, together with attendant jet tubes 64 and heating elements for blocks 70, shall be referred to as the patterning head 71. FIG. 5 depicts a highly schematicized patterning head 71 comprised of ten jet-forming tubes 64 of uniform size, for example, having an inside diameter within the range of about 0.005 inches to about 0.05 inches, depending upon the level of detail and definition desired in the pattern. For patterning at a resolution of 80 d.p.i., tubes having an inside diameter within the range of 0.01 inches to 0.014 inches have been found effective, particularly diameters near the center of that range. Patterns having gauges of greater than 40 (i.e., having a resolution greater than 40 d.p.i. in at least one direction) can easily be achieved (assuming an appropriate substrate is used) using the novel system described herein, with patterns having gauges within the range of 50 to 100 or more preferred if truly high definition patterns are desired.

Because the pressure of the air associated with each jet is highly specific to that jet and to that pattern data cycle, it is not practical to provide the heated air from a common manifold, as has been done in the prior art. Among other techniques (e.g., individual servo-controlled heating elements for each jet), one approach that has been shown to be effective is shown in more detail in FIGS. 5 and 6. A plurality of individual tubes 64 that form the patterning jets are arranged and aligned in an array that is embedded in a solid heat source structure comprised of heater blocks 70 that can serve as a high capacity heat reservoir. Tubes 64 are embedded within the interface of two machined blocks 70 in a manner that maximizes the contact between the outer surface of tubes 64 and blocks 70. Blocks 70 are preferably constructed of a material having relatively high heat capacity (i.e., able to “store” thermal energy effectively) and high heat conductivity, such as copper and/or brass, and serve as a solid heat reservoir (i.e., one which functions as a high mass heat source).

Once brought to a desired temperature by providing appropriate power to heating elements within structure 70, this arrangement can provide, via conduction through the walls of tubes 64, sufficient heat energy to bring the air passing through tubes 64 to a uniform, pre-determined temperature, regardless of the volume or velocity of air that passes through the tubes 64. The length of the tubes must be sufficient to allow pressurized air traveling through the tubes 64 to reach the desired temperature; accordingly, tube lengths of at least several inches are recommended. The composition of jet tubes 64 preferably is a material that readily transmits thermal energy, for example, brass, and the interface between the outside of the tubes and the mating surfaces of blocks 70 is preferably filled with a material that promotes heat conduction from blocks 70 to the interior of jet tubes 64. As an example, heat conduction pastes can be used and, where economically appropriate, the outside of each of the tubes may be gold plated or otherwise treated to improve heat conduction. It is further contemplated that surface of blocks 70 that contact the outside of jet tubes 64 may be similarly gold plated or otherwise treated to maximize heat conduction into the interior of the jet tubes (e.g., by preventing the formation of a copper oxide layer from forming and impeding heat flow).

Ports 76 (FIG. 5) serve as access points for electric heating elements that are positioned in intimate contact with interior portions of blocks 70. Exemplary heating elements are high temperature cartridge heaters such as those available from McMaster Carr, of Atlanta, Ga. Although two ports 76 are shown and are thought to be adequate, three or more could be used (with appropriate cartridge heaters) to further assist in maintaining a uniform temperature within blocks 70, particularly if large volumes of air will be passed through jet tubes 64 for relatively extended periods. Not shown on the opposite side of blocks 70 from ports 76 is at least one temperature sensor, which may be installed within blocks 70. This temperature sensor, which corresponds to temperature sensor 32 in FIG. 1, provides a real time measure of the temperature of blocks 70, and, by implication, the temperature of the patterning jets 38 exiting jet-forming tubes 64 (once factors such as heat conduction from blocks 70 to the walls of jet tubes 64, and heat transfer from the walls of jet tubes 64 to the column of air moving through such jet tubes, are accounted for by initial calibration procedures).

The ten pattern jet tubes 64 shown in FIG. 5 are positioned within blocks 70 so that, when viewed from the perspective of the surface of the fabric to be patterned, the individual tubes are arranged in something of a stair-step configuration, i.e., in a straight line, but along a diagonal such that the interior diameters of jet tubes provide continuous or nearly continuous lateral coverage when viewed along the path taken by the fabric to be patterned. Not apparent from the views of FIGS. 5 and 6 is a slight curvature to the profile of the configuration, so that the exit opening of each jet tube 64 is precisely the same distance from the surface of roll 62 that supports fabric 60. By so doing, two objectives are achieved—the diagonal configuration allows for closer lateral packing of the jet-forming tubes (i.e., higher d.p.i. across the face of the patterning head, without having to account for the wall thickness of the tubes), and the cross-sectional profiles of the various patterning jets will be made more uniform as they contact the fabric at the target location. Such curvature is unnecessary if the target locations on the fabric for all the patterning jets are co-planar.

A third control loop exists within FIG. 1 in the form of patterning head (indicated functionally at 30 and physically at 70 in FIGS. 5 and 6), temperature sensor 32, and heat controller 34. The function of this loop, which shall be referred to as the heat control loop, is to assure that, for a given pattern, the temperature of the air passing through patterning jets and onto the surface of the fabric to be patterned is uniform and non-varying, both from jet to jet and over time. The temperature of heater blocks 70 (embodied in depicted structure 30) is monitored in real time by temperature sensor 32 and sent to heat controller 34, which, analogous to signal comparator 20, compares the actual temperature of blocks 70 with the “set point” temperature needed to achieve the desired pattern effect. For each temperature control loop cycle in which the two temperatures are found to be different, a “temperature error” signal is generated and the power to electric heating elements associated with ports 76 is adjusted by an appropriate increment to minimize the temperature error signal during the next temperature control loop cycle. Note that, for a given pattern, the set point will commonly remain the same over all pattern data cycles. Accordingly, the set point likely will only need adjustment if a different pattern is used, if the nature of the substrate is changed, or if a different pattern “look” is desired. For many fabric substrates, set points within the range of about 400° F. and about 550° F., representing the internal temperature of blocks 70 and translating to patterning jet temperatures within the range of about 350° F. to about 490° F. on the substrate surface, will be used for most patterning operations. In a preferred operating environment, the temperature of the exiting air stream is high enough to heat set the fibers as the patterning jet passes over the fabric, but not high enough to induce melting.

Because of the significant lag to be expected between the thermal energy imparted by heating elements installed in ports 76 and the corresponding rise in temperature of blocks 70 as detected by temperature sensor 32, temperature control loop may be operated on a cycle frequency that is equivalent or even somewhat lower than the frequency of the pattern data cycle with little effect on overall pattern appearance, particularly if the appearance of the substrate being patterned is not sensitive to relatively small changes in temperature (e.g., no greater than a few degrees Fahrenheit).

It has been found that the pressurized heated air pulse representing the output of one pattern data cycle, once delivered to the “supply” end of jet tube 64 (the “proximal” end), may not dissipate as quickly as needed to allow tubes 64 to accommodate freely the next pressurized air pulse—the air pulse simply does not dissipate as fast as it builds, despite the fact that the “delivery” end of the jet tube 64 (the distal end, closest to the fabric) is open ended and exposed to atmospheric pressure. The result can be a delay in the pattern jet turn-off, particularly if the immediately preceding pattern was done at a relatively high pressure. It is therefore suggested that the “supply” end of tubes 64 be connected to atmospheric pressure or a slight vacuum immediately following the end of a given pattern pulse. This allows the stored pneumatic energy to be dissipated not only through the delivery end of the jet tube 64, but also through the supply end. This “patterning tube exhaust” function is also provided for in the Pneutronics Model SE 03561 valve assembly discussed above, but can be implemented independently using means that will be apparent to those skilled in the art.

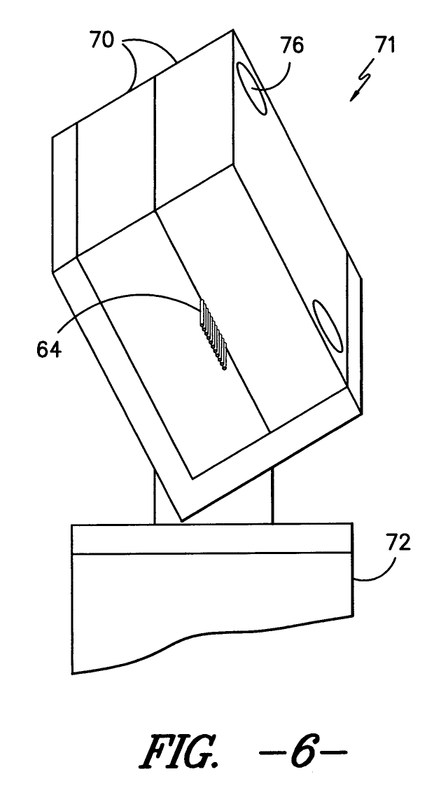

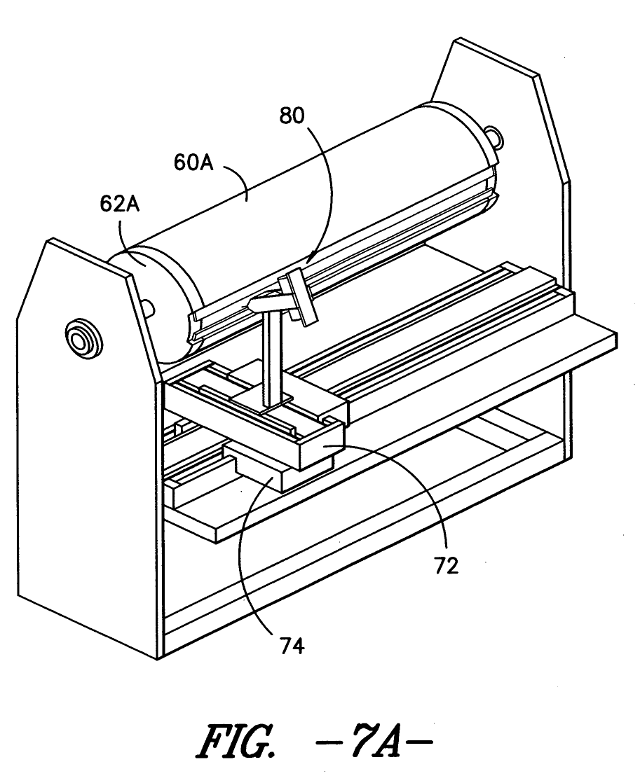

FIG. 7A depicts one embodiment of a device employing the teachings herein. Patterning head 80 (analogous to patterning head 71 shown in FIGS. 5 and 6) is installed on a traversing mechanism 74 that allows it to index across the face of rotating support roll 62A, to which is attached (via conventional means) the substrate to be patterned. Patterning head 80 may contain one, several, or many individual jet tubes 64.

FIG. 7B depicts a version of the device of FIG. 7A that has been adapted to pattern a substrate in the form of a continuous web. The traversing patterning head of FIG. 7A is replaced with patterning head 74 that extends the full width of support roll 62, over which moving substrate 60 is transported. Not shown, jet tubes 64 within patterning head 74 may be arranged in a repeating diagonal configuration, similar to that shown in FIGS. 5 and 6, (perhaps via use of contiguous discrete pattern head modules) extending laterally across the face of support roll 62, in which jet tubes 64, with provisions made for effective temperature control along the length of the patterning head. Optionally, if an array of discrete pattern head modules is used, each such module may be associated with its own temperature control loop.

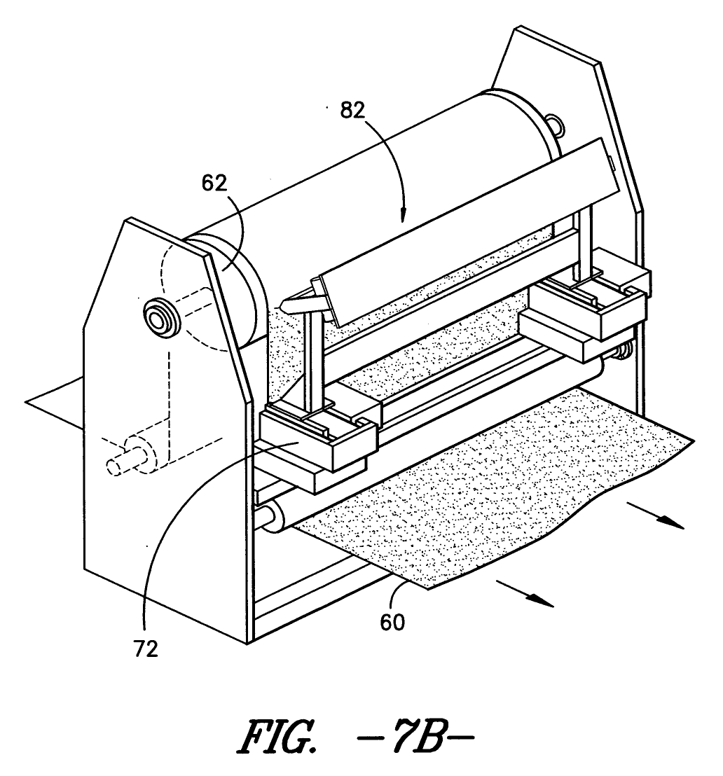

FIGS. 8A and 8B are graphical depictions of a pile fabric patterned using the device of FIG. 7A. As seen from FIG. 8B (a cross section taken from VIIIB-VIIIB of FIG. 8A), the carve depth exhibits both gradual and abrupt portions (depicted at 58 and 59, respectively) and exemplifies the high definition patterning that characterizes this patterning system.

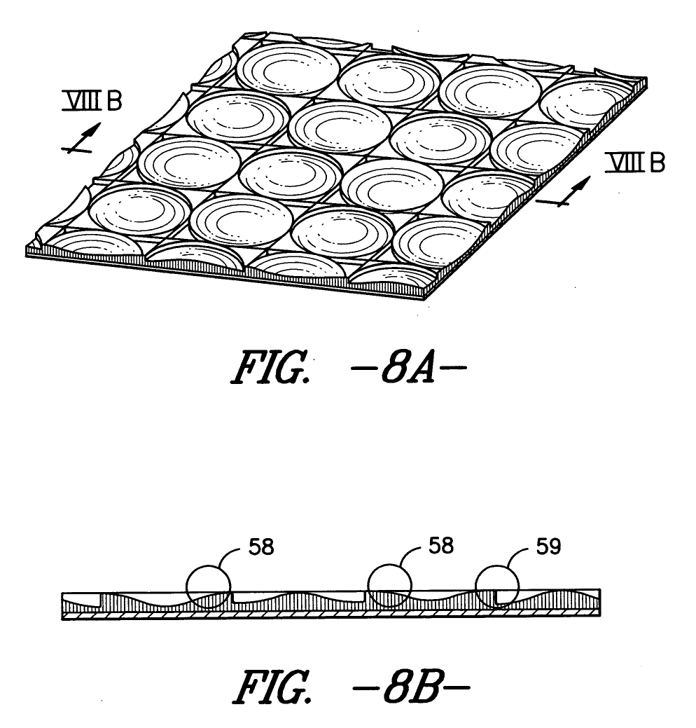

FIG. 9 is a plan view of the surface of a pile fabric patterned using the techniques disclosed herein. The fabric carries a pattern that imparts a complex texture to the fabric, along with a “Tromp d'Oeil”-like illusion of three-dimensional, sinuous pleats or gathers. While the fabric has a sculpted pile face with dramatically different carve depths within the overall pattern, the fabric itself is flat (i.e., the back of the fabric is completely planar).

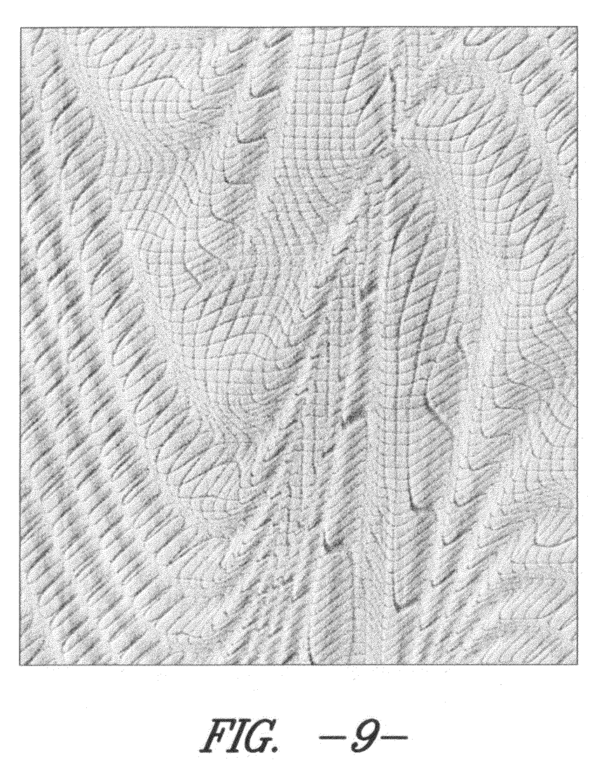

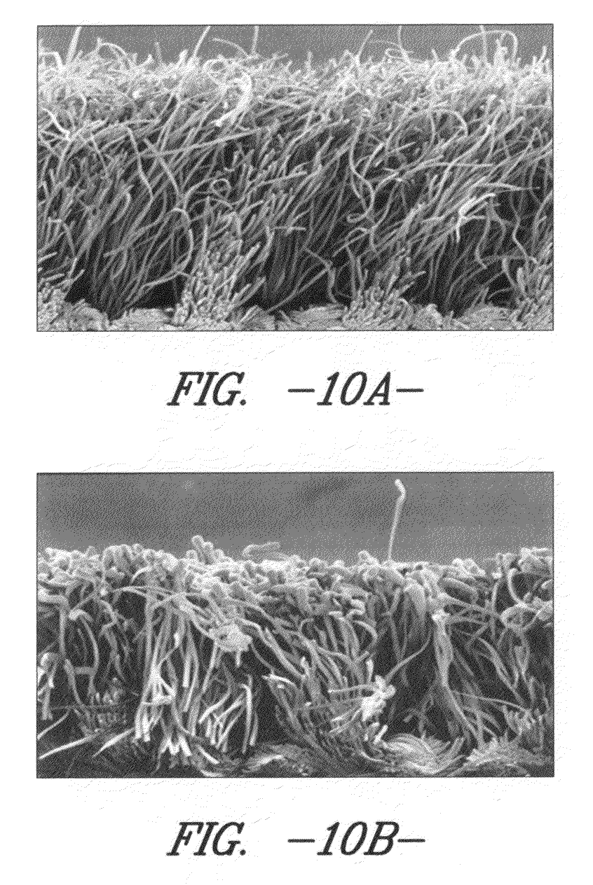

FIGS. 10A through 10C are electron photomicrographs of a 100% clipped knit polyester pile fabric that exemplifies the on-fabric patterning effects to be expected form the novel patterning system disclosed herein. FIG. 10A is a cross-section (35×) of the pile prior to patterning. FIG. 10B is a cross-section of patterned areas of the fabric of FIG. 9A, seen at slightly higher magnification (50×), that have been patterned using the techniques of U.S. Pat. No. 5,148,583 and that show melting of the tips of the pile yarns in the patterned area. FIG. 10C is a similar view of the fabric of FIG. 10B, but the view is of patterned areas that were patterned using the novel techniques disclosed herein. Note that some pile yarns are displaced more than others, and, as a group, the yarns exhibit displacement in multiple directions, possibly as a result of the turbulence generated by the impingement of the patterning jets. Note also the absence of melting of the pile yarns in the treated (i.e., patterned) area.

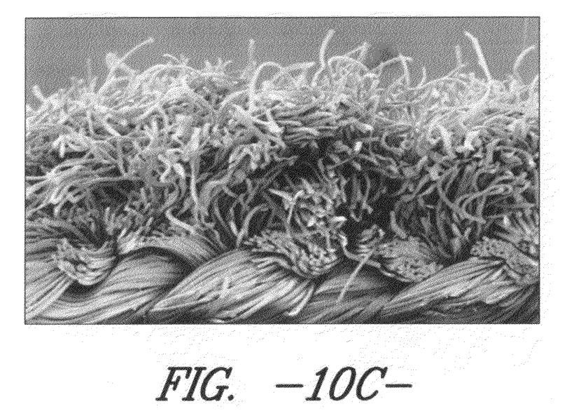

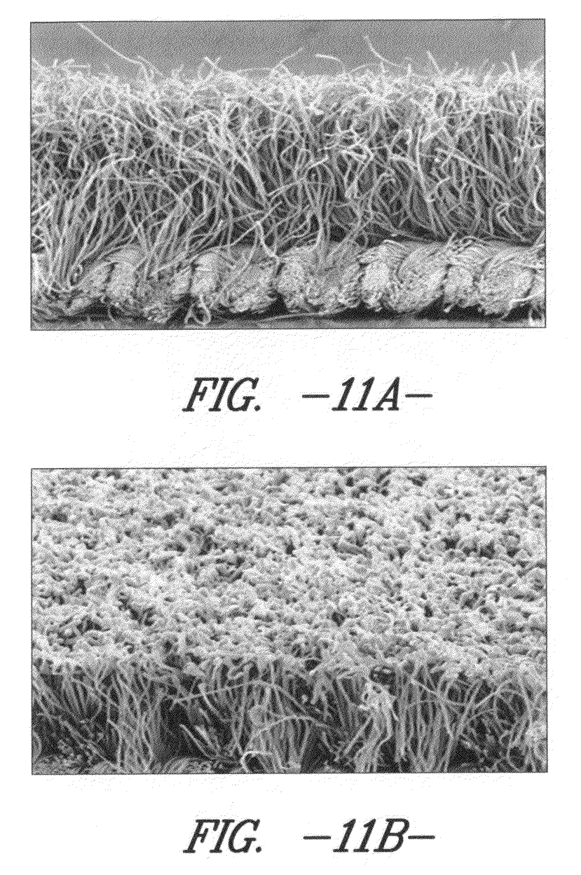

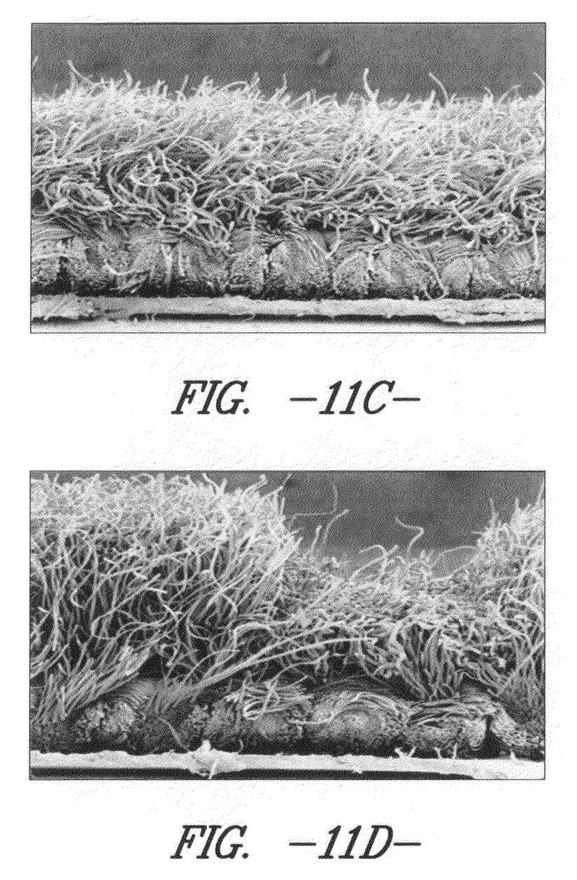

FIGS. 11A through 11D are electron photomicrographs of another 100% clipped knit polyester pile fabric that further exemplifies the on-fabric patterning effects to be expected form the novel patterning system disclosed herein. FIG. 11A is a cross-section view of the surface of untreated fabric at 30×. FIG. 11B is an oblique view, at 30×, of the surface of the fabric of FIG. 11A, patterned using the teachings of U.S. Pat. No. 5,148,583. Note the substantial swelling of the pile yarn tips that indicates significant melting in the yarn tip areas has occurred and that forms a crust-like surface in the patterned area that is believed responsible for the stiff, harsh hand associated with this patterning technique. FIGS. 11C and 11D are cross-sectional views (30×) of the surface of the fabric of FIG. 11A, patterned using the novel techniques disclosed herein. In FIG. 11C, the pile yarns have been subjected to multiple degrees of overall displacement (i.e., both with respect to direction and extent of displacement) and heat setting, resulting in intermediate carve depths. FIG. 11D is a cross-section view of the fabric of FIG. 11A showing a groove-like pattern feature on the right indicative of deep carving (with multiple degrees of pile displacement, but in a direction tending towards the observer) and an unpatterned area on the left. Note that, in both Figures, there is the complete absence of visible swelling or melting of the tips of the pile yarns or fibers in the patterned areas.

We claim:

1. A system for using electrically encoded pattern data to pattern a heat-settable substrate having surface elements that form a pile-like surface, said system comprising at least one air stream that is directed onto the surface of said substrate during each of a succession of pattern data cycles, said air stream having a pressure that is sufficient to displace at least some of said surface elements, said pressure being varied in predetermined discrete increments in accordance with said pattern data but being uniform during any given pattern data cycle, said air stream further having a temperature that is sufficient to heat set said displaced surface elements but insufficient to melt said displaced surface elements.

2. The system of claim 1 wherein said increments are sufficiently closely spaced to provide for substantially continuous variations in carve depth in accordance with said pattern data.

3. The system of claim 1 wherein said air stream pressure is maintained within said pattern data cycle through the use of a control loop.

4. The system of claim 1 wherein said air stream temperature is maintained at a constant value.

5. The system of claim 4 wherein said temperature is maintained through the use of a solid heat reservoir.

6. The system of claim 4 wherein said temperature is maintained by the use of a control loop.

7. An apparatus for patterning a heat-settable substrate having surface elements that form a pile-like surface, said apparatus comprising:
(a) a pressurized fluid source;
(b) a source of electrically-encoded pattern data that specifies, for each pattern data cycle, a discrete pressure value and transmits such value to a valve connected to said pressure source, said valve being capable of modulating, using discrete pressure levels, the pressure of said pressurized fluid in accordance with said pressure value encoded in said pattern data;
(c) a passage for forming said pressure-modulated fluid from said valve into a patterning jet that is directed towards the surface of said substrate at a pressure sufficient to selectively displace at least some of said surface elements in accordance with said pattern data; and
(d) a source of heat for maintaining the temperature of said patterning jet at a value sufficient to heat set said displaced surface elements when said patterning jet is directed towards said pile-like surface but insufficient to melt said surface elements.

8. The apparatus of claim 7 which further includes a conveyer for transporting said heat settable substrate while said patterning jet is being directed towards said pile-like surface.

9. The apparatus of claim 7 having a plurality of passages and valves, each such passage being in independent fluidic communication with a respective valve that can vary independently the pressure of such patterning jet formed by said passage with respect to the pressure of patterning jets formed by all other such passages.

10. The apparatus of claim 7 wherein said pressure of said patterning jet is controlled by a servo loop.

11. The apparatus of claim 7 wherein said temperature of said patterning jet is controlled by a servo loop.

12. The apparatus of claim 7 wherein the delivery of pattern data from said source of pattern data is coordinated with said conveyor, to provide for the properly timed arrival of pattern data to said valve.

13. The apparatus of claim 12 wherein said delivery of pattern data is facilitated by the use of a servo loop.

14. The apparatus of claim 7 wherein said passage has a cross-section that forms a patterning jet capable of imparting a pattern having a resolution of at least 50 d.p.i.

15. The apparatus of claim 7 wherein said passage has a cross-section that forms a patterning jet capable of imparting a pattern having a resolution of at least 60 d.p.i.

16. A heat-settable substrate having thermoplastic surface elements that form a pile-like surface, said substrate having areas in which said surface elements have been heated, then selectively displaced relative to surface elements in adjacent areas while in a heated state, said displaced elements being heated sufficiently during displacement to cause said displaced surface elements to become heat set while remaining unmelted, and forming a pattern having a gauge greater than 40.

17. The substrate of claim 16 in which said selectively displaced surface elements exhibit multiple degrees of displacement, resulting in at least ten different discrete levels of carve.

18. The substrate of claim 17 in which said multiple degrees of displacement are adjacent, and wherein carve depth is substantially continuous.

19. The substrate of claim 18 in which said displaced surface elements form a pattern having a gauge of at least 50.

20. The substrate of claim 16 in which said substrate is comprised of polyester.
